(19) United States
(12) Patent Application Publication
(10) Pub. No.: US 2014/0307993 A1
(43) Pub. Date: Oct. 16, 2014

(54) ELECTRO-OPTIC MODULATOR

(71) Applicant: HON HAI PRECISION INDUSTRY CO., LTD., New Taipei (TW)

(72) Inventor: HSIN-SHUN HUANG, New Taipei (TW)

(73) Assignee: HON HAI PRECISION INDUSTRY CO., LTD., New Taipei (TW)

(21) Appl. No.: 13/973,953

(22) Filed: Aug. 22, 2013

(30) Foreign Application Priority Data
Apr. 10, 2013 (TW) 102112593

(51) Int. Cl. G02F 1/01

(52) U.S. Cl. CPC G02F 1/011
USPC 385/2

(57) ABSTRACT

An electro-optic modulator includes a substrate having a top surface, and a waveguide having an input section, an output section, a first branch, and a second branch. The input section, the output section, and the first branch extends along a same straight line.

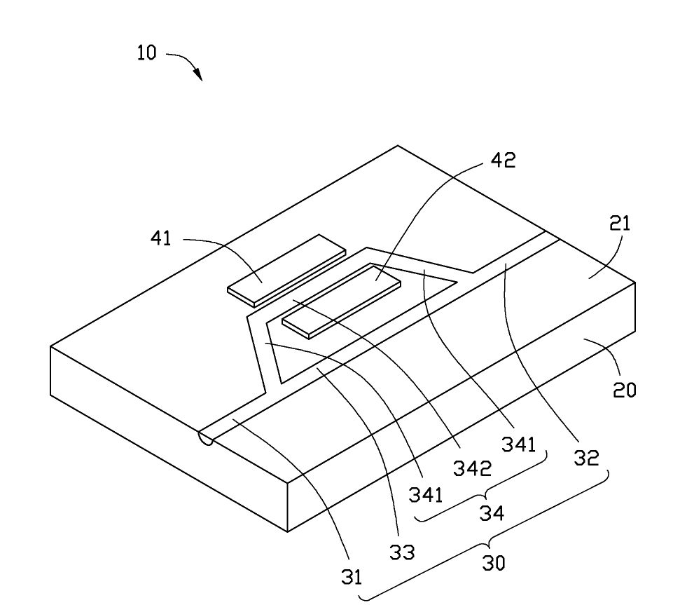

### BACKGROUND

1. Technical Field

The present disclosure relates to a Mach Zehnder electro-optic modulator.

2. Description of Related Art

Mach Zehnder modulators for modulating optical signals are known. Typically a two-armed Mach Zehnder modulator will split an incoming signal into two signals. A sinusoidal electric field is applied to one of the signal paths. This produces a phase shift in the optical signal in that path. The phase shifter optical signal is then recombined with the signal in the other arm. The constructive/destructive recombination of the two optical waves provides a modulation in the intensity of the output optical signal as a function of the applied electric field. Although existing Mach Zehnder modulators can satisfy basic requirements, a new type of Mach Zehnder modulator is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The drawing is an isometric schematic view of an electro-optic modulator according to one embodiment.

### DETAILED DESCRIPTION

Embodiments of the present disclosure will be described with reference to the accompanying drawings.

Referring to the drawing, a Mach Zehnder electro-optic modulator 10 includes a substrate 20 and a wave guide 30 embedded in the top surface 21 of the substrate 20. The wave guide 30 includes an input section 31, an output section 32, a first branch 33, and a second branch 34.

In the embodiment, the substrate 20 is made of lithium niobate (LiNbO3) crystal that can increase a bandwidth of the electro-optic modulator 10 as the LiNbO3 crystal has a high response speed.

In the embodiment, the input section 31 and the output section 32 are formed by diffusing titanium into the substrate 20. The first branch 33 is formed by diffusing titanium into the substrate and then diffusing zinc-nickel alloy into the substrate 20. The second branch 34 is formed by diffusing titanium into the substrate and then further diffusing Gallium into the substrate 20. The input section 31, the output section 32, and the first branch 33 have the same width, and extend along the same straight line.

In the embodiment, the second branch 34 includes two oblique portions 341 that are connected to the first branch 33 at its opposite ends. The first branch 33 further includes a parallel portion 342 that is parallel to the first branch 33, and connected to the oblique portions 341 at their ends.

In the embodiment, the electro-optic modulator 10 further includes a first electrode 41 and a second electrode 42 that are arranged on the top surface 21 of the substrate 20. The first electrode 41 and the electrodes 42 are parallel to and located at opposite sides of the parallel portion 342 of the second branch 34.

Since the input section 31, the output section 32, and the first branch 33 have the same width, and extend along the same straight line, there are no transition points between the input section 31, the output section 32, and the first branch 33, thereby decreasing the optical loss because of scattering at transition points.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An electro-optic modulator comprising:
a substrate comprising a top surface; and
a waveguide comprising an input section, an output section, a first branch, and a second branch, the input section, the output section, and the first branch extending along a same straight line.

2. The electro-optic modulator according to claim 1, wherein the substrate is made of lithium niobate crystal.

3. The electro-optic modulator according to claim 1, wherein the input section, the output section, the first branch, and the second branch are formed by diffusing titanium into the substrate.

4. The electro-optic modulator according to claim 1, wherein the input section, the output section, and the first branch have a same width.

5. The electro-optic modulator according to claim 1, further comprising two electrodes arranged on the top surface of the substrate.

6. The electro-optic modulator according to claim 5, wherein the second branch comprises two oblique segments obliquely connected to opposite ends of the first branch, and a parallel segment parallel to the first branch and connected between the two oblique segments.

7. The electro-optic modulator according to claim 6, wherein the two electrodes are parallel to the parallel segment and located at opposite sides of the parallel segment.
